(19) United States
(12) Patent Application Publication
(10) Pub. No.: US 2015/0292917 A1
(43) Pub. Date: Oct. 15, 2015

(54) ENCODER, SERVO AMPLIFIER, CONTROLLER, AND INFORMATION EXCHANGE METHOD IN SERVO SYSTEM

(71) Applicant: MITSUBISHI ELECTRIC CORPORATION, Tokyo (JP)

(72) Inventors: Yoichi Omura, Tokyo (JP); Jun Hattori, Tokyo (JP); Shigeo Jimbo, Tokyo (JP); Kazutaka Takahashi, Tokyo (JP)

(73) Assignee: Mitsubishi Electric Corporation, Tokyo (JP)

(21) Appl. No.: 14/440,109

(22) PCT Filed: Jan. 11, 2013
(86) PCT No.: PCT/JP2013/050450

§ 371 Date: May 1, 2015

(51) Int. Cl. G01D 5/347; G05B 19/19; H02P 6/16

(52) U.S. Cl. CPC G01D 5/3473; H02P 6/16; G05B 19/19

(57) ABSTRACT

An encoder includes a storing unit that retains information concerning a servo amplifier connected in the past. The encoder detects an operation state of a servomotor driven by a servo amplifier connected anew.

### FIELD

The present invention relates to an encoder attached to a servomotor, a servo amplifier that drives the servomotor, a controller that controls the servomotor, and an information exchange method in a servo system.

### BACKGROUND

Patent Literature 1 discloses a technology for storing, in an encoder, parameters such as a relation between an output of the encoder and an amount of movement on a machine side and acquiring the control parameters from the encoder when a control device is replaced.

For example, paragraph[0027] of Patent Literature 1 describes “Because control parameters peculiar to a machine apparatus incorporating an encoder are stored in an auxiliary storage device 20 (an EEPROM), an external control device can always acquire the control parameters. Therefore, when the machine apparatus is installed, the machine apparatus and the external control device can be optionally combined and operated. In this case, because the control parameters peculiar to the machine apparatus can be acquired using another control device during a failure and during maintenance of a control device connected to the machine apparatus, it is made possible to replace the control device with some other control device or combine the control device with some other control device and operate the control device. Therefore, maintenance work can be easily performed.”

### CITATION LIST

### Patent Literature

Patent Literature 1: Japanese Patent Application Laid-Open No. 2002-202157

### SUMMARY

### Technical Problem

However, according to the conventional technology, the parameters to be stored are only an origin position of a machine system and the encoder output/the machine side movement amount, and life information and secular change information peculiar to the machine are not stored. Therefore, when a servo amplifier is replaced, the life information cannot be inherited, and parameters need to be input again concerning the secular change information. Consequently, there is a problem in that the replacement takes time.

There is no mechanism for storing a replacement history of plural times of replacement. Further, concerning the life information of a servomotor, there is no mechanism for storing, when the servomotor is replaced, life information of the servomotor used last time.

The present invention has been devised in view of the above and it is an object of the present invention to obtain an encoder, a servo amplifier, a controller, and an information exchange method in a servo system that can inherit information such as life information, secular change information, and a replacement history even after replacement of a device.

### Solution to Problem

In order to solve the aforementioned problems, an encoder according to one aspect of the present invention includes a storing unit that retains information concerning a servo amplifier connected in the past, wherein the encoder detects an operation state of a servomotor driven by a servo amplifier connected anew.

### Advantageous Effects of Invention

The encoder according to the present invention can update parameters of the servo amplifier when the servo amplifier is simply connected to the encoder. Therefore, it is made possible to save setting work. Further, there is an effect that it is made possible to inherit life information and secular change information of the servo amplifier used before replacement, it is made possible to utilize the life information and the secular change information for preventive maintenance of the servo amplifier after the replacement, and also it is made possible to check an appropriate energization cumulative time of a device.

### BRIEF DESCRIPTION OF DRAWINGS

FIG. 1 is a diagram showing the configuration of a servo system according to a first embodiment of the present invention.

FIG. 2 is a flowchart for explaining an information exchange method in the servo system according to the first embodiment of the present invention.

FIG. 3 is a diagram showing a state in which a setting value (a filter frequency) of a resonance filter changes with time in the servo system according to the first embodiment of the present invention.

FIG. 4 is a flowchart for explaining an information exchange method in a servo system according to a second embodiment of the present invention.

FIG. 5 is a diagram showing the configuration of a servo system according to a third embodiment of the present invention.

### DESCRIPTION OF EMBODIMENTS

Exemplary embodiments of an encoder, a servo amplifier, a controller, and an information exchange method in a servo system according to the present invention are explained in detail below with reference to the drawings.

Note that the present invention is not limited by the embodiments.

### First Embodiment

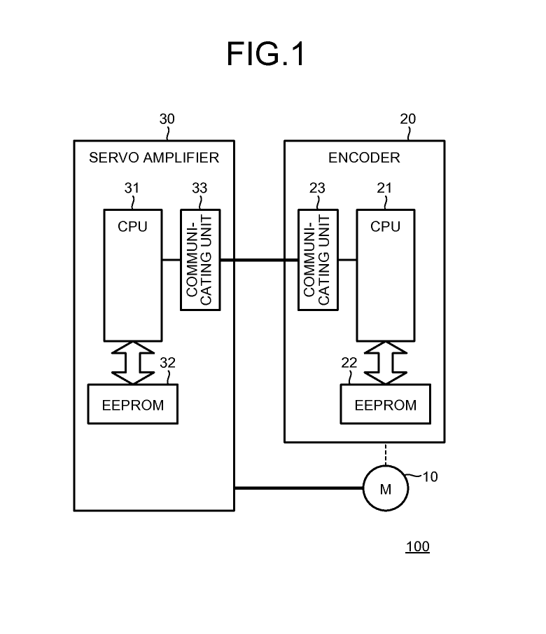

FIG. 1 is a diagram showing the configuration of a servo system 100 according to a first embodiment of the present invention. The servo system 100 includes a servomotor 10, an encoder 20 connected to the servomotor 10, and a servo amplifier 30 that drives the servomotor 10 on the basis of detection information received from the encoder 20. The encoder 20 is a sensor that detects an angle, the number of revolutions, and the like of a rotating shaft of the servomotor 10. The servo amplifier 30 drives the servomotor 10 on the basis of a detection result of the encoder 20. The encoder 20 includes a CPU 21, a storing unit 22 (an EEPROM), and a communicating unit 23. The servo amplifier 30 includes a CPU 31, a storing unit 32 (an EEPROM), and a communicating unit 33.

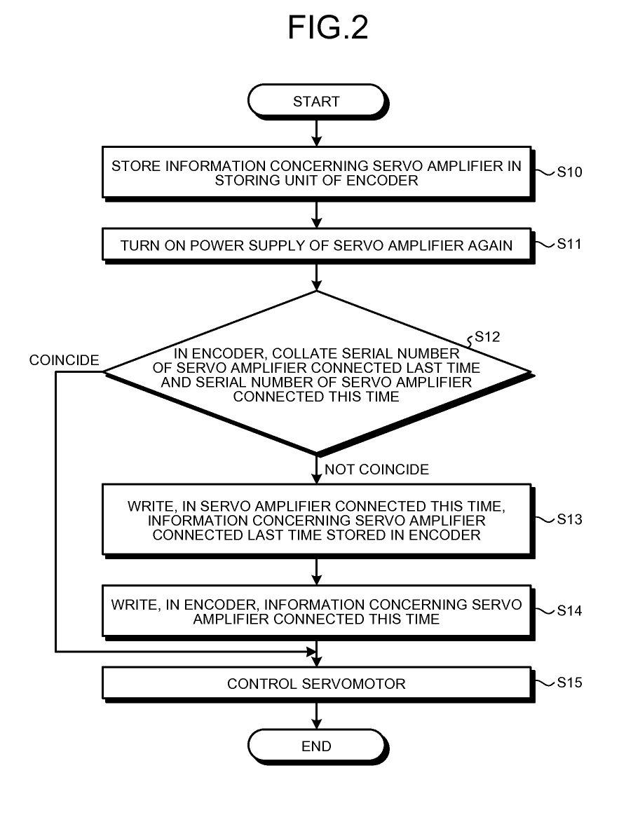

FIG. 2 is a flowchart for explaining an information exchange method in the servo system 100 according to the first embodiment of the present invention. First, when a power supply of the servo amplifier 30 is in a turned-on state (the power supply is ON), the servo system 100 stores, in the storing unit 22, for example, the EEPROM of the encoder 20 via the CPU 31, the communicating unit 33, the communicating unit 23, and the CPU 21 (step S10), information concerning the servo amplifier 30 such as control parameter information, an operation history, life information, secular change information, and further a serial number (serial information) of the servo amplifier 30 stored in the storing unit 32, for example, the EEPROM of the servo amplifier 30 (step S10). These kinds of information concerning the servo amplifier 30 can be stored in addition to or by overwriting information concerning the servo amplifier 30 connected last time or further in the past than the last time already stored in the storing unit 22 of the encoder 20.

Thereafter, when the power supply of the servo amplifier 30 is turned on again in a state of the configuration shown in FIG. 1 irrespective of presence or absence of replacement of the servo amplifier 30 (step S11), first, the servo system 100 collates, in the encoder 20, a serial number (serial information) of the servo amplifier 30 connected last time stored in the storing unit 22 and a serial number of the servo amplifier 30 connected this time (step S12). Consequently, it is made possible to determine presence or absence of update of the servo amplifier 30.

When the serial information of the servo amplifier 30 connected last time and the serial information of the servo amplifier 30 connected this time coincide with each other (coincide at step S12), the servo system 100 directly starts control of the servomotor 10 (step S15). When the serial number of the servo amplifier 30 connected last time and the serial number of the servo amplifier 30 connected this time do not coincide with each other (not coincide at step S12), the servo system 100 writes, in the storing unit 32 of the servo amplifier 30 connected this time, information concerning the servo amplifier 30 connected last time, for example, control parameter information, an operation history, life information, and secular change information of the servo amplifier 30 stored in the storing unit 22 of the encoder 20 (step S13). For example, the servo system 100 overwrites the control parameter information and additionally writes the operation history, the life information, and the secular change information. Subsequently, the servo system 100 writes, in the storing unit 22 of the encoder 20, information such as a serial number (serial information), an operation history, life information, and secular change information of the servo amplifier 30 connected this time in addition to the information concerning the servo amplifier 30 connected last time (step S14). When the servo amplifier 30 connected this time is a new product, the operation history, the life information, the secular change information, and the like thereof are initial values. Note that the order of step S13 and step S14 can be opposite. Thereafter, the servo system 100 starts control of the servomotor 10 (step S15). When control parameters of the servo amplifier 30 are changed, the servo system 100 changes control parameters stored in the storing unit 22 of the encoder 20 by overwriting the control parameters every time the control parameters are changed.

The control parameter information of the servo amplifier 30 indicates parameters for servo control such as a gain adjustment parameter, an input output setting parameter, and an electronic gear ratio and parameters for servo control estimated by the servo amplifier such as an inertial ratio. The operation history indicates a serial number, a replacement history including date and time, an alarm history, and operation information during alarm occurrence of the servo amplifier 30. The life information indicates information concerning the life of the servo amplifier 30 such as an energization cumulative time of the servo amplifier 30 and the number of ON/OFF times of a rush relay in the servo amplifier 30.

The life information further includes information concerning the life of a capacitor in the servo amplifier 30. The secular change information is information indicating a state and a life on a device side that changes over time such as a setting value and a friction amount of a resonance filter provided in the servo amplifier 30 to prevent resonance on the device side. The secular change information indicates information from the start of use to immediately before replacement of the servo amplifier 30.

The information written in the storing unit 22 of the encoder 20 is not limited to the information concerning the servo amplifier 30 connected last time. It can be arranged such that information concerning the servo amplifier 30 connected the time before last or before the time before last is stored, and thereafter other information is written in the storing unit 22 of the encoder 20 in addition to the stored information. Consequently, it is made possible to check a replacement cycle of the servo amplifier 30.

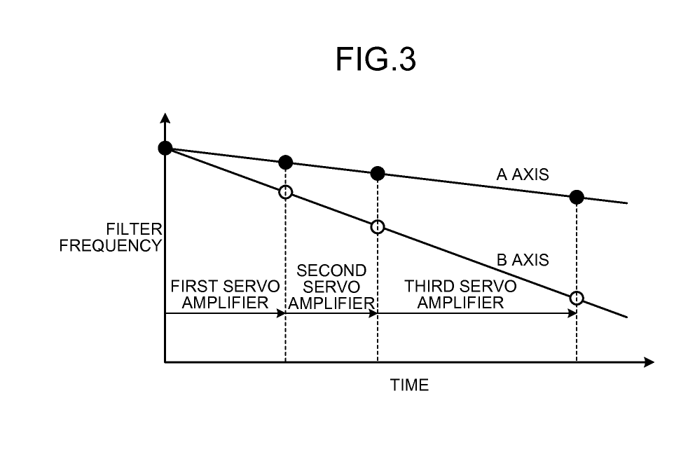

For example, a state in which a setting value (a filter frequency) of a resonance filter changes with time is shown in FIG. 3 as an example of the secular change information. The abscissa indicates time and the ordinate indicates the setting value (the filter frequency) of the resonance filter. When the servomotor 10, the encoder 20, and the servo amplifier 30 are set on, for example, an A axis and a B axis, which are two axes different from each other, in general, the setting value of the resonance filter for preventing resonance on the device side and in the system including the servo control system is different on the A axis and the B axis and changes with time. That is, the setting value of the resonance filter gradually changes according to a period of use and device fluctuation. If the servo amplifier 30 includes an automatic setting function for the resonance filter, when readjustment is automatically carried out on the servo amplifier 30 aide, a filter setting value after the readjustment is stored in addition to the initially-set filter setting value. A setting history of the filter setting value is stored in the storing unit 32 of the servo amplifier 30 and the storing unit 22 of the encoder 20.

After a fixed period, when a first servo amplifier 30 is replaced with a second servo amplifier 30, secular change information of a filter setting value in the first servo amplifier 30 stored in the storing unit 22 of the encoder 20 is additionally written in the second servo amplifier 30. The second servo amplifier 30 can start operation with a filter setting value optimum for the device immediately after the replacement. Further, when the second servo amplifier 30 is replaced with a third servo amplifier 30, secular change information of filter setting values in the first and second servo amplifiers 30 stored in the storing unit 22 of the encoder 20 is additionally written in the third servo amplifier 30. The third servo amplifier 30 can start operation with a filter setting value optimum for the device immediately after the replacement. In this way, in this embodiment, the optimum filter setting value in the nearest past in the servo amplifier 30 used until immediately before the replacement can be used immediately after the replacement. Therefore, it is possible to save resetting work after the replacement.

Further, by inheriting the secular change information as explained above, for example, it is also possible to check the difference between changes of filter setting values on the A axis and the B axis as shown in FIG. 3. Consequently, it is seen that a mechanical factor for a change in filter setting is present on the A axis and the B axis because of the device. Therefore, for example, it is also made possible to utilize the secular change information for preventive maintenance of the device such as readjustment of the B axis, on which the change is large compared with the A axis, review of a mechanical configuration, review of conditions of a surrounding environment, and review of an operation pattern.

In the conventional servo system, when a servo amplifier of a pulse input type is replaced at a customer's site, parameters of a new servo amplifier are in a state of the factory default and need to be set every time the servo amplifier is replaced. Further, life information is not inherited after the replacement.

Therefore, in this embodiment, the parameter information and the serial number of the servo amplifier 30 are stored in the storing unit 22 of the encoder 20 of the servomotor 10 connected to the servo amplifier 30. When only the servo amplifier 30 is replaced, the servo amplifier 30 reads out the parameters of the servo amplifier 30 stored in the storing unit 22 of the encoder 20 and updates parameter setting. Information to be stored in the encoder 20 includes, besides the parameters of the servo amplifier 30, life information (an energization cumulative time and the number of ON/OFF times of a rush relay), secular change information (a filter setting value) of the servo amplifier 30. Data to be stored in the storing unit 22 of the encoder 20 may include parameters and the like of not only the servo amplifier 30 connected and used last time but also the servo amplifier 30 used the time before last or before the time before last.

With the configuration of the servo system 100 explained above, by simply connecting the servo amplifier 30, it is made possible to update the parameters of the servo amplifier 30 on the basis of the information stored in the storing unit 22 of the encoder 20. Therefore, it is possible to save setting work. In manual setting, parameters on a different axis are likely to be set by mistake. However, according to this embodiment, it is possible to prevent such wrong setting of the parameters. Further, it is possible to inherit the life information. Therefore, it is made possible to check an approximate energization cumulative time of the device. It is made possible to inherit the operation history, the life information, and the secular change information of the servo amplifier 30 used before the replacement. Therefore, it is made possible to utilize the operation history, the life information, and the secular change information for preventive maintenance of the servo amplifier 30 and the device after the replacement. Note that, in the above explanation, the encoder 20 is explained as an example of the device connected to the servo amplifier 30. However, the device connected to servo amplifier 30 can be other device as long as the information concerning the servo amplifier 30 can be retained.

### Second Embodiment

In the first embodiment, the form in which the information concerning the servo amplifier 30 is written in the encoder 20 is explained. However, in this embodiment, in the configuration shown in FIG. 1, conversely, information concerning the encoder 20 and the servomotor 10, for example, serial information, operation histories, life information, and secular change information of the encoder 20 and the servomotor 10 are stored in the storing unit 32 of the servo amplifier 30.

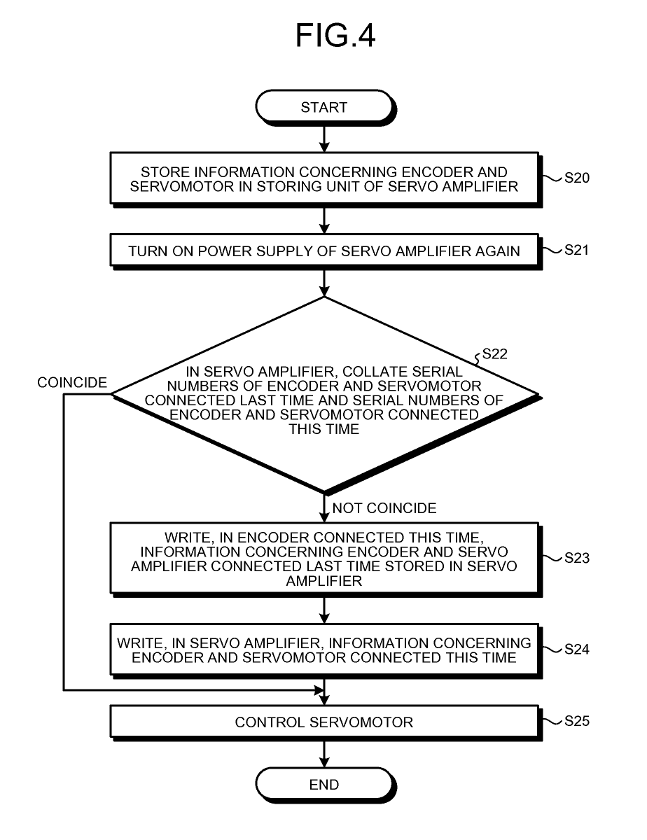

FIG. 4 is a flowchart for explaining an information exchange method in the servo system 100 according to the second embodiment of the present invention. First, when the power supply of the servo amplifier 30 is in a turned-on state (the power supply is ON), the servo system 100 stores, in the storing unit 32, for example, the EEPROM of the servo amplifier 30 via the CPU 21, the communicating unit 23, the communicating unit 33, and the CPU 31, information concerning the encoder 20 and the servomotor 10, for example, serial information (a serial number of the encoder 20 or the servomotor 10), operation histories, life information, secular change information, and cumulative operation times (servo-on times) of the encoder 20 and the servomotor 10 (step S20). These kinds of information concerning the encoder 20 and the servomotor 10 can be stored in addition to or by overwriting information concerning the encoder 20 and the servomotor 10 connected last time or further in the past than the last time already stored in the storing unit 32 of the servo amplifier 30.

Thereafter, when the power supply of the servo amplifier 30 is turned on again in the state of the configuration shown in FIG. 1 irrespective of presence or absence of replacement of the encoder 20 and the servomotor 10 (step S21), first, the servo system 100 collates, in the servo amplifier 30, serial numbers (serial information) of the encoder 20 and the servomotor 10 connected last time stored in the storing unit 32 and serial numbers of the encoder 20 and the servomotor 10 connected this time (step S22). Consequently, it is made possible to determine presence or absence of update of the encoder 20 and the servomotor 10.

When the serial information of the encoder 20 and the servomotor 10 connected last time and the serial information of the encoder 20 and the servomotor 10 connected this time coincide with each other (coincide at step S22), the servo system 100 directly starts servomotor control (step S25). When the serial information of the encoder 20 or the servomotor 10 connected last time and the serial information of the encoder 20 or the servomotor 10 connected this time do not coincide with each other (not coincide at step S22), the servo system 100 additionally writes, in the storing unit 22 of the encoder 20 connected this time, information concerning the encoder 20 and the servomotor 10 connected last time, for example, serial information, operation histories, life information, and secular change information of the encoder 20 and the servomotor 10 connected last time stored in the storing unit 32 of the servo amplifier 30 (step S23).

Note that, when the serial information of the encoder 20 or the servomotor 10 connected last time and the serial information of the encoder 20 or the servomotor 10 connected this time do not coincide with each other (not coincide at step S22), for example, it is conceivable that a serial number is given to a set of the encoder 20 and the servomotor 10 and, as a result of collating a serial number of the set of the encoder 20 and the servomotor 10, they do not coincide with each other. However, it is also conceivable that only the serial information of the encoder 20 connected last time and the serial information of the encoder 20 connected this time do not coincide with each other, or only the serial information of the servomotor 10 connected last time and the serial information of the servomotor 10 connected this time do not coincide with each other. This is because it is also likely that the encoder 20 and the servomotor 10 are not provided as a set.

Following step S23, the servo system 100 additionally writes, in the storing unit 32 of the servo amplifier 30, serial information, operation histories, and secular change information of the encoder 20 and the servomotor 10 connected this time (step S24). Note that the order of step S23 and step S24 can be opposite. Thereafter, the servo system 100 starts control of the servomotor 10 (step S25).

The serial information of the encoder 20 and the servomotor 10 is serial number and the like of the encoder 20 and the servomotor 10. The operation histories indicate replacement histories and the like including date and time of the encoder 20 and the servomotor 10. The life information indicates information concerning the lives of the encoder 20 and the servomotor 10 such as energization cumulative times. The secular change information is information indicating the states and the lives of the encoder 20 and the servomotor 10 and on the device side that change over time such as correction data of the encoder 20, and indicates information from the start of use until immediately before replacement of the encoder 20 and the servomotor 10. The correction data is, for example, data concerning correction relative to a secular change due to an environment of the encoder 20 and the servomotor 10. Specifically, the correction data is correction data or the like relative to light intensity of an LED for position detection used in the encoder 20.

The information to be written in the storing unit 32 of the servo amplifier 30 is not limited to the information concerning the encoder 20 and the servomotor 10 connected last time. It can be arranged such that information concerning the encoder 20 and the servomotor 10 connected the time before last or before the time before last is stored, and thereafter information is written in the storing unit 32 of the servo amplifier 30 in addition to that stored information. Consequently, it is made possible to check a replacement cycle of the encoder 20 and the servomotor 10.

With the configuration of the servo system 100 explained above, by simply connecting the encoder 20 and the servomotor 10 to the servo amplifier 30, it is made possible to determine, on the basis of the information stored in the storing unit 32 of the servo amplifier 30, whether the servomotor 10 on a correct axis is connected. Therefore, it is possible to prevent the servomotor 10 on a different axis from being connected by mistake. It is also possible to inherit the life information. Therefore, it is made possible to check approximate energization cumulative times of the encoder 20 and the servomotor 10. It is made possible to inherit the operation histories, the life information, and the secular change information of the encoder 20 and the servomotor 10 used before the replacement. Therefore, it is possible to utilize the operation histories, the life information, and the secular change information for preventive maintenance of the encoder 20 and the servomotor 10 after the replacement. Further, it is made possible to check an approximate operation time of the device.

### Third Embodiment

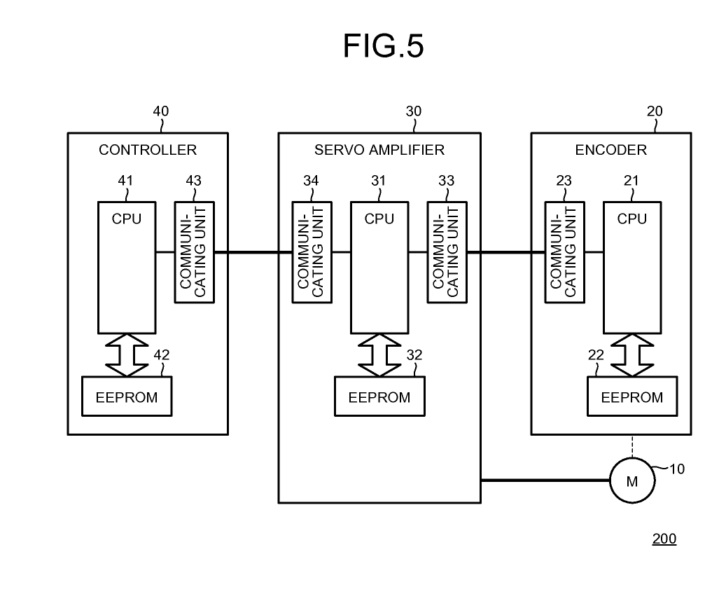

FIG. 5 is a diagram showing the configuration of a servo system 200 according to a third embodiment of the present invention. In FIG. 5, a controller 40 that controls the servo amplifier 30 is added to the configuration shown in FIG. 1. The controller 40 is, for example, a motion controller. The controller 40 includes a CPU 41, a storing unit 42 (an EEPROM), and a communicating unit 43. In this case, the servo amplifier 30 further includes a communicating unit 34 for communication with the controller 40.

In the first embodiment, the information concerning the servo amplifier 30 such as the parameter information, the operation history, the life information, and the secular change information of the servo amplifier 30 is stored in the storing unit 22 of the encoder 20. However, in this embodiment, the information concerning the servo amplifier 30 can be stored in another external device connectable to the servo amplifier 30, for example, in the storing unit 42 of the controller 40 and written in the storing unit 32 of a new servo amplifier 30 when the servo amplifier 30 is replaced. In an information exchange method in this case, the encoder 20 shown in FIG. 2 is replaced by the controller 40. The same effect can be obtained by distributedly storing the information concerning the servo amplifier 30 in the storing unit 22 of the encoder 20 and the storing unit 42 of the controller 40. In this case, the collation of the serial numbers at step S12 in FIG. 2 can be performed by any one of the encoder 20 and the controller 40.

In the second embodiment, the information concerning the encoder 20 and the servomotor 10, for example, the serial information, the operation histories, the life information, and the secular change information of the encoder 20 and the servomotor 10 is stored in the storing unit 32 of the servo amplifier 30. However, in this embodiment, the information concerning the encoder 20 and the servomotor 10 can be stored in another external device connectable to the servo amplifier 30, for example, the storing unit 42 of the controller 40 and written in the storing unit 22 of a new encoder 20 when the encoder 20 and the servomotor 10 are replaced. In an information exchange method in this case, the servo amplifier 30 is replaced by the controller 40 at steps other than step S21. The same effect can be obtained by distributedly storing the information concerning the encoder 20 and the servomotor 10 in the storing unit 32 of the servo amplifier 30 and the storing unit 42 of the controller 40. In this case, the collation of the serial numbers at step S22 in FIG. 4 can be performed by any one of the servo amplifier 30 and the controller 40.

The present invention is not limited to the above-explained embodiments. At an implementation stage, the present invention can be variously modified without departing from the spirit of the present invention. Inventions at various stages are included in the embodiment. Various inventions can be extracted according to appropriate combinations in the disclosed constituent elements. For example, when the problems described in the technical problem can be solved and the effects described in the advantageous effects of invention can be obtained even if several constituent elements are deleted from all the constituent elements described in the embodiments, a configuration in which the constituent elements are deleted can be extracted as an invention. Further, the constituent elements described in the different embodiments can be combined as appropriate.

### INDUSTRIAL APPLICABILITY

As explained above, the encoder, the servo amplifier, the controller, and the information exchange method in the servo system according to the present invention are useful in inheriting history information of the devices configuring the servo system after replacement of the devices and is, in particular, suitable for inheriting secular change information such as a setting value of a resonance filter and facilitating resetting work after the replacement.

### REFERENCE SIGNS LIST

10 Servomotor
20 Encoder
30 Servo amplifier
40 Controller
21, 31, 41 CPUs
22, 32, 42 Storing units
23, 33, 34, 43 Communicating units
100, 200 Servo systems

1-16. (canceled)

17. An encoder comprising a storing unit that retains life information of a servo amplifier connected in the past, wherein the encoder detects an operation state of a servomotor driven by a servo amplifier connected anew.

18. An encoder comprising a storing unit that retains secular change information of a servo amplifier connected in the past, wherein the encoder detects an operation state of a servomotor driven by a servo amplifier connected anew.

19. The encoder according to claim 17, wherein the storing unit also retains secular change information of the servo amplifier connected in the past.

20. The encoder according to claim 17, wherein the storing unit also retains serial information of the servo amplifier connected in the past.

21. The encoder according to claim 18, wherein the storing unit also retains serial information of the servo amplifier connected in the past.

22. A servo amplifier comprising a storing unit that retains life information or secular change information of an encoder connected in the past for detection of an operation state of a servomotor, the information of a servomotor connected in the past, or the information of an encoder connected in the past for detection of the operation state of the servomotor and a servomotor connected in the past, wherein
the servo amplifier drives a servomotor connected at present.

23. The servo amplifier according to claim 22, wherein the storing unit also retains serial information of the encoder connected in the past, serial information of the servomotor connected in the past, or serial information of the encoder connected in the past and the servomotor connected in the past.

24. A controller comprising a storing unit that retains life information of a servo amplifier connected in the past, wherein the controller drives a servomotor by controlling a servo amplifier connected anew.

25. A controller comprising a storing unit that retains secular change information of a servo amplifier connected in the past, wherein the controller drives a servomotor by controlling a servo amplifier connected anew.

26. The controller according to claim 24, wherein the storing unit also retains secular change information of the servo amplifier connected in the past.

27. The controller according to claim 24, wherein the storing unit also retains serial information of the servo amplifier connected in the past.

28. The controller according to claim 25, wherein the storing unit also retains serial information of the servo amplifier connected in the past.

29. A controller comprising a storing unit that retains life information or secular change information of an encoder connected to a servo amplifier in the past for detection of an operation state of a servomotor, the information of a servomotor connected to the servo amplifier in the past, or the information of an encoder connected to the servo amplifier in the past for detection of the operation state of the servomotor and a servomotor connected to the servo amplifier in the past, wherein
the controller controls the servo amplifier.

30. The controller according to claim 29, wherein the storing unit also retains serial information of the encoder connected to the servo amplifier in the past, serial information of the servomotor connected to the servo amplifier in the past, or serial information of the encoder connected to the servo amplifier in the past and the servomotor connected to the servo amplifier in the past.

31. An information exchange method in a servo system including a servomotor, an encoder that detects an operation state of the servomotor, and a servo amplifier that drives the servomotor on the basis of a detection result of the encoder, the information exchange method comprising:
a step of retaining, in a storing unit of the encoder, life information or secular change information of a servo amplifier connected to the servo system in the past;
a step of writing, in a storing unit of a servo amplifier connected to the servo system anew, the life information or the secular change information retained in the storing unit of the encoder; and
a step of writing, in the storing unit of the encoder, life information or the secular change information of the servo amplifier connected to the servo system anew.

32. An information exchange method in a servo system including a servomotor, an encoder that detects an operation state of the servomotor, and a servo amplifier that drives the servomotor on the basis of a detection result of the encoder, the information exchange method comprising:
a step of retaining, in a storing unit of the servo amplifier, life information or secular change information of an encoder connected to the servo system in the past or the information of the encoder and the servomotor;
a step of writing, in a storing unit of an encoder connected to the servo system anew, the life information or the secular change information retained in the storing unit of the servo amplifier; and
a step of writing, in the storing unit of the servo amplifier, life information or secular change information of the encoder connected to the servo system anew or the information of the encoder and the servomotor.

33. An information exchange method in a servo system including a servomotor, an encoder that detects an operation state of the servomotor, a servo amplifier that drives the servomotor on the basis of a detection result of the encoder, and a controller that controls the servo amplifier, the information exchange method comprising:
a step of retaining, in a storing unit of the controller, life information or secular change information of a servo amplifier connected to the servo system in the past;
a step of writing, in a storing unit of a servo amplifier connected to the servo system anew, the life information or the secular change information retained in the storing unit of the controller; and
a step of writing, in the storing unit of the controller, life information or secular change information of the servo amplifier connected to the servo system anew.

34. An information exchange method in a servo system including a servomotor, an encoder that detects an operation state of the servomotor, a servo amplifier that drives the servomotor on the basis of a detection result of the encoder, and a controller that controls the servo amplifier, the information exchange method comprising:
a step of retaining, in a storing unit of the controller, life information or secular change information of an encoder connected to the servo system in the past or the information of the encoder and the servomotor;
a step of writing, in a storing unit of an encoder connected to the servo system anew, the life information or the secular change information retained in the storing unit of the controller; and
a step of writing, in the storing unit of the controller, life information or secular change information of the encoder connected to the servo system anew or the information of the encoder and the servomotor.
